(19) United States
(12) Patent Application Publication
(10) Pub. No.: US 2005/0015768 A1
(43) Pub. Date: Jan. 20, 2005

(54) System and method for providing hardware-assisted task scheduling

(76) Inventor: Mark Justin Moore, Cambridge (GB)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/747,248

(22) Filed: Dec. 30, 2003

Related U.S. Application Data
(60) Provisional application No. 60/437,043, filed on Dec. 31, 2002.

(51) Int. Cl. G06F 15/173

(52) U.S. Cl. 718/102

(57) ABSTRACT

A method, system and computer-readable medium for scheduling tasks, wherein a task switch request is initially received. A scheduling processor prioritizes the available tasks and inserts a highest priority task state into a first address register associated with a CPU. Next, the CPU suspends operation of the currently executing task and inserts a state of the suspended task into a second address register associated with the CPU. The CPU loads the task state from the first address register associated with the CPU and resumes the loaded task loaded. The scheduling processor then retrieves the task state from the second address register by the scheduling processor and schedules the retrieved task for subsequent execution.

### CROSS-REFERENCE TO RELATED APPLICATIONS

The present application claims priority to co-pending U.S. Provisional Patent Application No. 60/437,043, filed Dec. 31, 2002, the entirety of which is incorporated by reference herein.

### BACKGROUND OF THE INVENTION

The present invention relates generally to the field of computer systems and, more particularly, to systems for scheduling process execution to provide optimal performance of the computer system.

The operation of modern computer systems is typically governed by an operating system (OS) software program which essentially acts as an interface between the system resources and hardware and the various applications which make requirements of these resources. Easily recognizable examples of such programs include Microsoft WindowsTM, UNIX, DOS, VxWorks, and Linux, although numerous additional operating systems have been developed for meeting the specific demands and requirements of various products and devices.

In general, operating systems perform the basic tasks which enable software applications to utilize hardware or software resources, such as managing I/O devices, keeping track of files and directories in system memory, and managing the resources which must be shared between the various applications running on the system. Operating systems also generally attempt to ensure that different applications running at the same time do not interfere with each other and that the system is secure from unauthorized use.

Depending upon the requirements of the system in which they are installed, operating systems can take several forms. For example, a multi-user operating system allows two or more users to run programs at the same time. A multiprocessing operating systems supports running a single application across multiple hardware processors (CPUs). A multitasking operating system enables more than one application to run concurrently on the operating system without interference. A multithreading operating system enables different parts of a single application to run concurrently. Real time operating systems (RTOS) execute tasks in a predictable, deterministic period of time. Most modern operating systems attempt to fulfill several of these roles simultaneously, with varying degrees of success.

Of particular interest to the present invention are operating systems which optimally schedule the execution of several tasks or threads concurrently and in substantially real-time. These operating systems generally include a thread scheduling application to handle this process. In general, the thread scheduler multiplexes each single CPU resource between many different software entities (the ‘threads’) each of which appears to its software to have exclusive access to its own CPU. One such method of scheduling thread or task execution is disclosed in U.S. Pat. No. 6,108,683 (the '683 patent). In the '683 patent, decisions on thread or task execution are made based upon a strict priority scheme for all of the various processes to be executed. By assigning such priorities, high priority tasks (such as video or voice applications) are guaranteed service before non critical or real-time applications. Unfortunately, such a strict priority system fails to address the processing needs of lesser priority tasks which may be running concurrently. Such a failure may result in the time-out or shut down of such processes which may be unacceptable to the operation of the system as a whole.

Another known system of scheduling task execution is disclosed in U.S. Pat. No. 5,528,513 (the '513 patent). In the '513 patent, decisions regarding task execution are initially made based upon the type of task requesting resources, with additional decisions being made in a round-robin fashion. If the task is an isochronous, or real-time task such as voice or video transmission, a priority is determined relative to other real-time tasks and any currently running general purpose tasks are preempted. If a new task is a general purpose or non-real-time task, resources are provided in a round robin fashion, with each task being serviced for a set period of time. Unfortunately, this method of scheduling task execution fails to fully address the issue of poor response latency in implementing hard real-time functions. Also, as noted above, extended resource allocation to real-time tasks may disadvantageously result in no resources being provided to lesser priority tasks.

Accordingly, there is a need in the art of computer systems for a system and method for scheduling the execution system processes which is both responsive to real-time requirements and also fair in its allocation of resources to non-real-time tasks.

### BRIEF SUMMARY OF THE INVENTION

The present invention overcomes the problems and disadvantages set forth above by providing a method, system and computer-readable medium for scheduling tasks, wherein a task switch request is initially received. A scheduling processor prioritizes the available tasks and inserts a highest priority task state into a first address register associated with a CPU. Next, the CPU suspends operation of the currently executing task and inserts a state of the suspended task into a second address register associated with the CPU. The CPU loads the task state from the first address register associated with the CPU and resumes the loaded task loaded. The scheduling processor then retrieves the task state from the second address register by the scheduling processor and schedules the retrieved task for subsequent execution.

### BRIEF DESCRIPTION OF THE DRAWINGS

The present invention can be understood more completely by reading the following Detailed Description of the Preferred Embodiments, in conjunction with the accompanying drawings.

FIG. 1 is a generalized block diagram illustrating a hardware system 100 for scheduling and executing tasks in accordance with the present invention.

FIG. 2 is a flow chart illustrating one embodiment of a method for scheduling tasks in accordance with the present invention.

### DETAILED DESCRIPTION OF THE PREFERRED EMBODIMENTS

The basic motivation for thread scheduling system of the present invention, is to reduce the overhead associated with context switching between tasks in an operating system. In a real-time operating system running many tasks (e.g., a network communications processor), the overheads of switching task contexts can consume a substantial proportion of the total CPU time. In general, a task is any single flow of execution and is analogous to an ATMOS process or a UNIX thread. Further, multiplexing of the CPU hardware between many tasks may be referred to as context switching. Such multiplexing can be accomplished in several ways, such as 1.) providing one dedicated CPU core per task, 2.) providing a hardware task switch on the CPU itself, and 3.) providing a software task switch.

It is assumed that the number of required tasks is greater than the number of possible CPU cores, so the first solution above can only be a partial solution. If it is assumed that the target CPU core is an ARM (or most other standard CPU cores), the second option is not available, since hardware tasks switches in these environments are not possible. Accordingly, for the assumes scenario, the solution must incorporate a software driven task switch.

Context switches may occur in response to pre-emptive time-slicing, wake requests (e.g.; by making a sleeping task runnable), or sleep requests from running task (e.g.; on read of an empty queue). For an ARM system, context switches can therefore occur as a result of interrupts (FIQ or IRQ), queue operations or software sleep requests. If queue operations are implemented in hardware, the ARM pre-fetch abort exception is a convenient way to force a task-suspend, while a dedicated FIQ or IRQ interrupt provides pre-emptive scheduling and task-wake functionality.

Accordingly, the general technique of the present invention is to remove as many of the processes as possible from the main system CPU to a separate scheduling processor, leaving only the operations that cannot easily be removed (assuming the main CPU is a standard processor which cannot be redesigned). In this manner, resources for the main CPU are maximized.

In one embodiment, processes which may be removed to the scheduling processor includes the following: the scheduling algorithm itself (i.e., deciding which task should run next, and deciding when to time-slice between tasks); the managing of task states, including each task's context information (which is largely represented by the contents of the CPU registers on most processors); and managing the information which controls task scheduling. In an operating system in which tasks communicate by using messages held on queues, a task is free to run unless it is suspended waiting for a message to arrive on an empty queue. The scheduler needs information relating to this suspension and queue arrival. Accordingly, the scheduling hardware also includes hardware to support the queue operations. Additionally, the scheduling hardware has all the task runnable/suspended information to hand, and can combine it with the conventional parameters such as task priorities, and timeslicing algorithms.

Through the implementation of designated scheduling hardware, the processes left to the main CPU are reduced to an absolute minimum. CPU processes may include the following: two fixed areas of memory reserved to hold 1.) the state of the current task, and 2.) the state of the next task chosen by the scheduler; suspension of the current task by dumping all registers into the “current task” memory area; and resuming the next task, by reloading all registers from the “next task” memory area.

Additionally, the main CPU is also provided with an interface for the scheduling hardware consisting of a number of hardware I/O registers mapped into its address space. The main processor uses these registers to initialize the scheduler, and to provide the arguments for queue operations, etc. Regarding the scheduling processor, it needs mechanisms to signal to the main CPU.

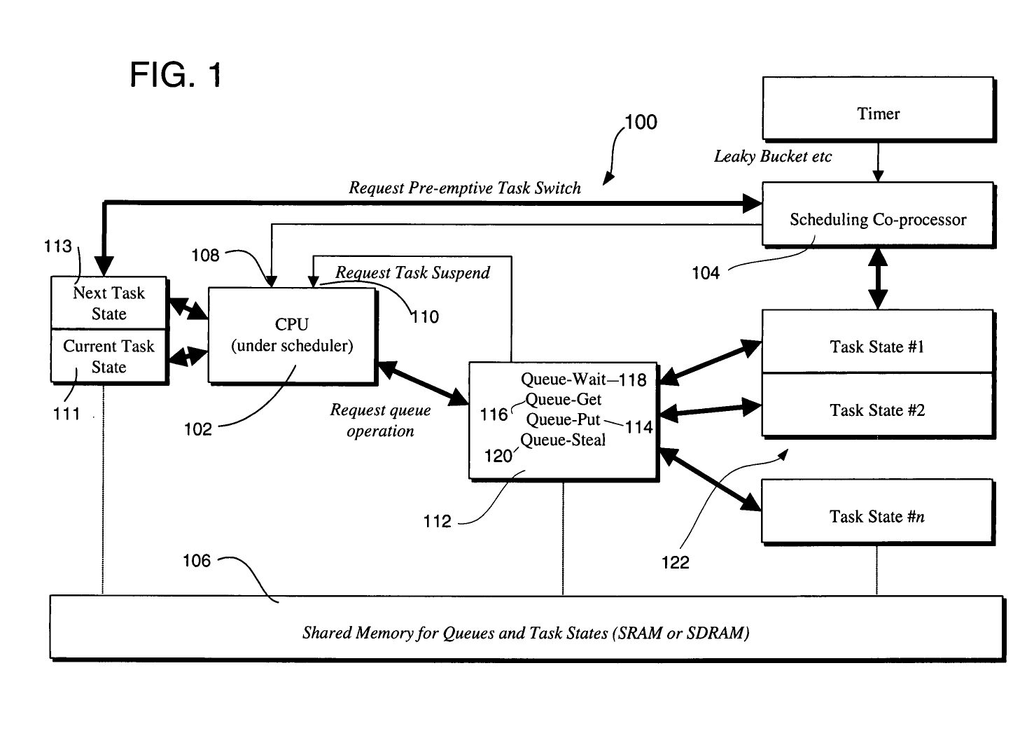

Referring now to FIG. 1, there is shown a generalized block diagram illustrating a hardware system 100 for scheduling and executing tasks in accordance with the present invention. The system 100 is designed to control a standard CPU core 102 such as an ARM or MIPS device using standard CPU bus signals such as interrupt and memory-abort. In general, the hardware system 100 may be used to implement any of a range of thread scheduling algorithms, based on a message exchange methodology. In one embodiment, the following operations are accelerated by the present invention: message handling; pre-emptive timeslicing between threads; timeslice computations; and synchronization and communication in multi-processor systems.

In addition to CPU 102, a discrete scheduling processor 104 is provided to assist with thread scheduling in the manner briefly disclosed above. A shared system memory 106 is further provided for maintaining the various queues and task states required by the present system. The CPU 102 includes a first input 108 for receiving a scheduler signal indicating that a pre-emptive task switch is required by issuing an interrupt to the CPU. Additionally, a second input 110 is provided for receiving a scheduler signal indicating that the current task must be suspended on a QueueGet operation. In one embodiment, task suspension is provided by raising a memory page-fault signal to the CPU 102 (in this manner, the operating system code in the CPU does not need any extra instructions to test whether a queue operation has worked—it simply initiates the queue operation via the hardware I/O registers, and if extra action is needed this will cause a page-fault exception which can invoke the appropriate routine).

CPU 102 further includes a first fixed memory area 111 for storing the state of the currently running task as well as a second fixed memory area 113 for storing the state of the next task. These memory areas are accessible to the scheduling processor 104 for enabling accurate scheduling of tasks.

Typically, conventional software schedulers incorporated into CPU's are limited by the finite size of the scheduler timeslice—often many milliseconds in modern systems. By providing hardware assist to the scheduling operation via the scheduling processor 104, the overhead of a thread context switch can be made dramatically smaller, either with a standard CPU core or with a modified core design. This allows much finer (microsecond level) timeslicing and hence improved real-time scheduling characteristics (which theoretically require an infinitesimal timeslice to provide idealized scheduler implementations). It should be understood that the hardware scheduling design may be rendered entirely in dedicated silicon, or in a software algorithm resident in a secondary CPU that offloads thread scheduling decisions from the CPU executing the threads.

Returning to FIG. 1, a queue manager 112 is shared between all CPUs on the system and performs queue maintenance duties for both the CPU 102 and the scheduling processor 104. Accordingly, if either processor 102 or 104 try to access the queue manager while it is servicing another request, the processor is held off in wait until the queue manager has completed both requests. As briefly set forth above, because the present operating system operates by means of exchanging messages, various queues are required to collect and manage the various messages. In a preferred embodiment, the queue manager is a hardware implementation of the following functions: QueuePut 114, QueueGet 116, QueueWait 118, and QueueSteal 120. The QueuePut function 114 is used to add an item to a queue. This operation may cause a task to become active if any task is currently waiting on the queue. The QueueGet 116 function is used to get an item from a queue, returning zero if the queue was empty. The QueueWait 118 function is used to get an item from a queue, waiting if necessary until something is available. Lastly, the QueueSteal 120 function is used to get the entire contents of a queue in a single operation.

The queue manager 112 interacts with shared memory 106 (SRAM, or preferably SDRAM) to holds the queue control structures and items on the queues. The queue control structure maintains the list information, the queue type (e.g., LIFO (last in first out), FIFO (first in first out), etc.) and any references to task structures. Additionally, the queue manager 112 also interacts with the scheduling processor 104 to assert a task-demand on any put operation. For efficiency in implementation, this may be limited in one embodiment to the queue transition from empty to non-empty. The queue manager can assert a task-demand on any get operation that results in the requesting CPU being suspended. This is used to implement efficient task-locking primitives between control and data-path execution threads. The queue manager 112 also interacts with the CPU 102 requesting a queue operation. The queue manager can request an immediate task-switch if a get operation would have failed to return a queue entry.

The scheduling processor 104 is responsible for maintaining and calculating which task should be executing at any given moment. The most probable scheduling algorithm is likely to be a weighted-queue-dual-leaky-bucket priority encoder. However, the exact algorithm is flexible should remain programmable. As such, in a preferred embodiment, the scheduler 104 includes a programmable co-processor element, rather than a dedicated hardware block. The scheduling processor preferably maintains an adaptable listing of task states 122 for subsequent relay to memory area 113 associated with CPU 102.

In operation, an immediate task-switch request is implemented by raising a memory-page-fault to the target CPU 102. The scheduling processor 104 preferably maintains a target process for immediate switches (e.g., the next highest priority task, or the idle task from listing 122) which is placed into the memory area 113 associated with CPU 102. A conventional abort handler on the target CPU implements the context switch accordingly.

For pre-emptive task switches, the scheduling processor 104 continuously re-calculates task priorities and may select to request a pre-emptive task switch. In operation, the scheduling processor 104 sets the target-task state in the memory area 113, then issues an interrupt to the controlled CPU 102. This then handles the context switch in a conventional manner.

On targets which are general purpose processors (e.g. ARM), the processor itself must perform the task switch. The scheduling processor 104 assists this by providing registers 111 and 113 that specify where to save the existing state (111) and from where to load the new state (113). Task-switch requests are triggered by the memory-abort signal or by the interrupt line.

Additionally, the queue manager 112 may issue task-demand requests to the scheduling processor 104. There are several ways to accomplish this. By maintaining a FIFO of requests, a small FIFO queue of tokens is maintained between the queue manager 112 and scheduling processor 104 (e.g., for a hard-limit of 256 tasks, a short 256-byte FIFO could queue requests to run a task with the specified 8 bit task index). This methodology minimizes complexity between the queue manager 112 and scheduling processor 104 and allows for ‘stalls’ in processing requests. In an alternative embodiment, the queue manager 112 writes directly into the task-control-block (e.g., 122) associated with the respective queue. For example, there may be a byte or word sized field that is set zero on suspend, non-zero on demand.

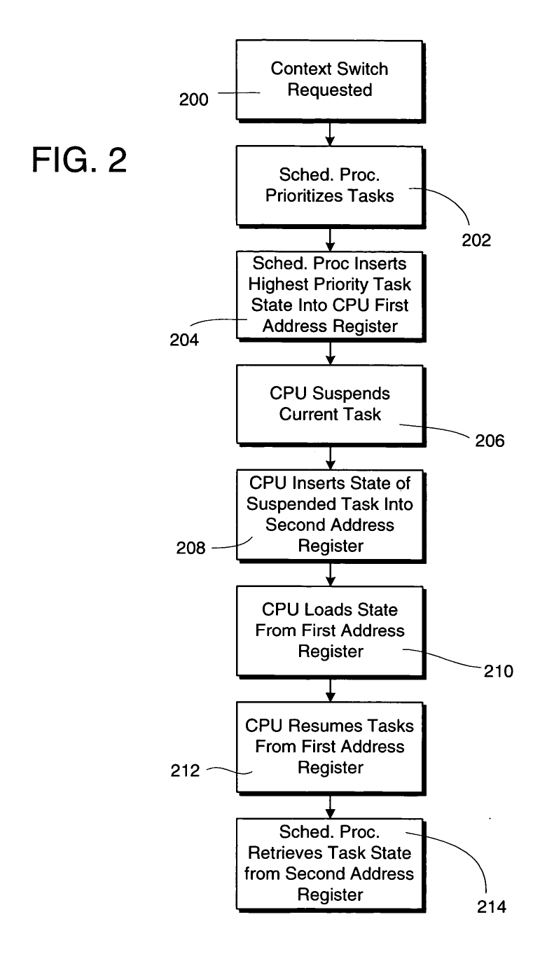

Referring now to FIG. 2, there is shown a flow diagram illustrating one embodiment of a method for scheduling tasks in accordance with the present invention. Initially, in step 200, a context switch is requested. Next, in step 202, a scheduling processor prioritizes available tasks and, in step 204, inserts a highest priority task state into a first address register associated with a CPU. In step 206, the CPU suspends operation of the currently executing task. In step 208, the CPU inserts the state of the suspended task into a second address register associated with the CPU. Next, in step 210, the CPU loads the state from the first address register associated with the CPU. In step 212, the CPU resumes the task loaded in step 210. In step 214, the task state from the second address register is retrieved by the scheduling processor for subsequent scheduling.

Example ARM Software Context Switch

The following example assumes the following: a FIQ is generated to request a context switch; a fixed area in memory 111 receives the saved state of the interrupted task; and a fixed area in memory 113 contains the saved state of the task to be resumed. In this manner, the code for IRQ or abort handlers is analogous, requiring only one extra branch operation. This yields the following code for an ARM processor:

; Address definitions.
; State areas are pointers to hardware regions containing
; the following:
;

| ; | Word | Usage |
|---|---|---|
| ; | 0-15 | Holds ARM register r0-r15 respectively |
| ; | 16 | Holds ARM PSR (Processor Status Register) |

;
; This code assumes that the content of these areas is
; managed by an external entity. They may be implemented
; either as dedicated hardware registers, or as blocks
; of SDRAM managed by a second processor (eg: the NP).
; The external managing entity “knows” the behaviour of the
; PP ARM FIQ code and can avoid modifying the saved state
; areas during the PP context switch. This can be achieved
; either by monitoring accesses to the state areas, by
; making assumptions about the speed of response of the PP
; to FIQ (probably a bad idea) or by adding an explicit
; handshake to the PP FIQ implementation (not included below).

| | |
|---|---|
| kSaveStateMapping equ | 0x10000 |
| kRestoreStateMapping | equ 0x20000 ; Could be same |

; Interrupt vector table.
; Normally mapped to physical address zero.
;

| | |
|---|---|
| org | 0 |

| | | |
|---|---|---|
| b | trap_reset | ; 0x00 |

| | | |
|---|---|---|
| b | trap_undefined | ; 0x04 |

| | | |
|---|---|---|
| b | trap_software_interrupt | ; 0x08 |

| | | |
|---|---|---|
| b | trap_prefetch_abort | ; 0x0c |

| | | |
|---|---|---|
| b | trap_data_abort | ; 0x10 |

| | | |
|---|---|---|
| b | trap_reserved | ; 0x14 |

| | | |
|---|---|---|
| b | trap_irq | ; 0x18 |

; FIQ Handling code.
; At this point:

| | | |
|---|---|---|
| ; | r0-r7 | Interrupted task registers |
| ; | r8 Ptr | to save state area |
| ; | r9 Ptr | to restore state area |
| ; | r10-r13 | Reserved |
| ; | r14 | Interrupted PC + 4 |
| ; | spsr | Interrupted PSR |
| ; | | |

| | | |
|---|---|---|
| stmia | r8, {r0-r15}\hat{ } | ; Save user-mode r0-r15 |
| mrs | r0, spsr_all | ; Get interrupted PSR |
| str | r0, [r8, #16*4] | ; Save PSR |

; Restore the next task state.

| | | |
|---|---|---|
| ldr | r0, [r9, #16*4] | ; Get saved PSR |
| msr | spsr_all, r0 | ; Transfer to FIQ SPSR |
| ldmia | r9, {r0-r15}\hat{ } | ; Restore r0-r15, SPSR->PSR |

Queues associated with the present invention include packet queues and preferably have a number of properties including type (FIFO vs LIFO), depth, list head pointer, list tail pointer (FIFO only), task reference for demand-on-put, and task reference for demand-on-underflow. Further, entries on a queue contain the link pointer only (assume that this is the first word of memory in the object).

LIFO linked lists are desirable for use in implementing shared buffer pools since they are 1.) faster than FIFO queues and 2.) may have favorable interactions with some DRAM cache architectures. Further, packet oriented data-path tasks all have an associated input and output queue. These may reference either a free-pool or another processing task: the software queue APIs should not distinguish between the FIFO or LIFO modes.

Maintaining symmetry of operations between task queues and free-lists is important as it avoids the need for a given task to if the destination is in anyway ‘special’. Processing ‘chains’ built from tasks linked by message queues may only using packet-queue operations—i.e., you cannot mix and match packet queues and circular buffering. This will need to be explicitly set forth in the task scheduler.

Additionally, there is no hard binding between tasks and queues. That is, a task may choose to wait on any queue that does not already have an associated task waiting for it. Queues are transiently marked to indicate which task (if any) should be woken if a queue-put operation adds data to a queue or which should be woken if a queue-get operation causes a queue-underflow. Any queue operation that triggers a task-schedule event must clear the associated task from the queue structure to permit the input queue for a given task to be changed dynamically.

FIFO lists are used to build ordered queues of network data packets, or ordered queues of inter-application control messages. The number of items is not limited by the queue control structure. Knowledge is required of the structure of objects to be enqueued. LIFO lists are used to build resource pools, such as buffer pools. A LIFO buffer pool architecture has beneficial cache interactions on some hardware platforms, and generally provides faster access than FIFO queues. The number of items is not limited by the queue control structure. Knowledge is required of the structure of objects to be enqueued.

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

1. A method for scheduling tasks, comprising:
receiving a task switch request;
prioritizing, by a scheduling processor, available tasks;
inserting a highest priority task state into a first address register associated with a CPU;
suspending operation of the currently executing task;
inserting a state of the suspended task into a second address register associated with the CPU;
loading the state from the first address register associated with the CPU;
resuming the task loaded from the first address register;
retrieving the task state from the second address register by the scheduling processor;
scheduling the retrieved task for subsequent execution.

2. The method of claim 1, wherein the CPU is an ARM-based CPU.

3. The method of claim 1, wherein the CPU is a MIPS-based CPU.

4. The method of claim 1, further comprising receiving a pre-emptive task switch request from the scheduling processor.

5. The method of claim 1, further comprising:
executing a message-transfer based operating system, wherein the message-transfer based operating system utilizes message queues to initiate and suspend task execution.

6. The method of claim 5, further comprising:
providing a queue manager operatively connected to the CPU and the scheduling processor, wherein the queue manager performs queue maintenance duties for the CPU and scheduling processor; and
receiving a task suspend request from a queue manager in reponse to at least one message transfer.

7. The method of claim 6, wherein the queue manager performs QueuePut, QueueGet, QueueWait, and QueueSteal operations.

8. A system for scheduling tasks, comprising:
a CPU for executing tasks; and
a scheduling processor for prioritizing available tasks, the scheduling processor operatively connected to the CP,
wherein the CPU receives a task switch request,
wherein the scheduling processor inserts a highest priority task state into a first address register associated with a CP,
wherein the CPU suspends operation of the currently executing task,
wherein the CPU inserts a state of the suspended task into a second address register associated with the CPU,
wherein the CPU loads the state from the first address register associated with the CPU,
wherein the CPU resumes the task loaded from the first address register,
wherein the scheduling processor retrieves the task state from the second address register, and
wherein the scheduling processor schedules the retrieved task for subsequent execution.

9. The system of claim 8, wherein the CPU is an ARM-based CPU.

10. The system of claim 8, wherein the CPU is a MIPS-based CPU.

11. The system of claim 8, wherein the CPU receives a pre-emptive task switch request from the scheduling processor.

12. The system of claim 8, wherein the CPU executes a message-transfer based operating system, wherein the message-transfer based operating system utilizes message queues to initiate and suspend task execution.

13. The system of claim 12, further comprising:
a queue manager operatively connected to the CPU and the scheduling processor, wherein the queue manager performs queue maintenance duties for the CPU and scheduling processor; and
wherein the CPU receives a task suspend request from a queue manager in response to at least one message transfer.

14. The system of claim 13, wherein the queue manager performs QueuePut, QueueGet, QueueWait, and QueueSteal operations.

15. A computer-readable medium incorporating tasks for scheduling tasks, comprising:
one or more instructions for receiving a task switch request;
one or more instructions for prioritizing, by a scheduling processor, available tasks;
one or more instructions for inserting a highest priority task state into a first address register associated with a CPU;
one or more instructions for suspending operation of the currently executing task;
one or more instructions for inserting a state of the suspended task into a second address register associated with the CPU;
one or more instructions for loading the state from the first address register associated with the CPU;
one or more instructions for resuming the task loaded from the first address register;
one or more instructions for retrieving the task state from the second address register by the scheduling processor;
one or more instructions for scheduling the retrieved task for subsequent execution.

16. The computer-readable medium of claim 15, wherein the CPU is an ARM-based CPU.

17. The computer-readable medium of claim 15, wherein the CPU is a MIPS-based CPU.

18. The computer-readable medium of claim 15, further comprising one or more instructions for receiving a pre-emptive task switch request from the scheduling processor.

19. The computer-readable medium of claim 15, further comprising:
one or more instructions for executing a message-transfer based operating system, wherein the message-transfer based operating system utilizes message queues to initiate and suspend task execution.

20. The computer-readable medium of claim 19, further comprising:
one or more instructions for providing a queue manager operatively connected to the CPU and the scheduling processor, wherein the queue manager performs queue maintenance duties for the CPU and scheduling processor; and
one or more instructions for receiving a task suspend request from a queue manager in reponse to at least one message transfer.

21. The computer-readable medium of claim 20, wherein the queue manager performs QueuePut, QueueGet, QueueWait, and QueueSteal operations.
